(19) United States
(12) Patent Application Publication
(10) Pub. No.: US 2005/0128885 A1
(43) Pub. Date: Jun. 16, 2005

(54) High density thermal recording and magnetic reading recording medium and system

(76) Inventors: Der-Ray Huang, Hsinchu (TW); Po-Cheng Kuo, Hsinchu (TW); Chao-Te Lee, Hsinchu (TW); Tzuan-Ren Jeng, Hsinchu (TW)

Correspondence Address: BIRCH STEWART KOLASCH & BIRCH, PO BOX 747, FALLS CHURCH, VA, 22040-0747, US

(21) Appl. No.: 10/786,047

(22) Filed: Feb. 26, 2004

(30) Foreign Application Priority Data
Dec. 16, 2003 (TW) 92135604

(51) Int. Cl. G11B 11/00

(52) U.S. Cl. 369/13.33; 369/13.35

(57) ABSTRACT

A high density thermal recording and magnetic reading recording medium and system combines near-field optical recording and the sensitive reading technique of the magneto-resistive head to overcome the restriction of optical diffraction limitation to increase the density of the recording medium. It mainly has sub-micro cylindrical lenses directly formed on the substrate of the recording medium to enable a near-field optical laser to write and generate smaller optical spots thereby to achieve smaller recording bits and increase the recording density.

### FIELD OF THE INVENTION

The present invention relates to a recording medium adopted for use in magnetic optical recording systems and particularly to a high-density thermal recording and magnetic reading recording medium that combines near-field optical recording and the reading technique of a sensitive magneto-resistive head.

### BACKGROUND OF THE INVENTION

How to increase the recording density of the recording media has always been an important issue in the field of recording media. The recording media, depending on different storing principles, may be divided into optical recording media and magnetic recording media. The optical recording media is restricted by optical diffraction limitation, while the magnetic recording media is restricted by super paramagnetic limitation, thus the recording density is difficult to increase as desired.

In recent years near-field optical and super resolution optical techniques have been adopted on optical disks to overcome the diffraction limitation of optical disk recording media. In the near-field optical techniques, a solid immersion lens (SIL) may be used to obtain an optical spot smaller than the diffraction limit, thereby a smaller recording bit may be formed to increase the recording density of the optical disk. However, the sliding distance between the objective lens and the disk has to be smaller than the wavelength of the laser light to generate a near-field effect. It makes design of the optical disk drive system more difficult. For instance, U.S. Pat. No. 6,614,742 discloses a technique that uses a solid immersion lens (SIL) for near-field recording. The SIL optical head requires a complex slider. Moreover, the distance between the optical head and the disk has to be maintained about 100 nm. This is very difficult in practical applications.

Guerra et al proposes an Integral Near-field Optical (INFO) technique, which directly uses a sub-micro cylindrical SIL on the substrate of the conventional DVD disk. It greatly shrinks the dimension of the optical spot and can increase the recording density of the optical disk. And the distance between the optical head and the optical disk does not need to be shrunk smaller than the wavelength of the laser light. It can resolve the hitting and scraping problem between the optical head and the optical disk during rotation of the optical disk caused by a too short distance there between in the near-field optical system. The recording density of the DVD disk may increase from 4.7 GB to 9.4 GB. (J. Guerra, D. Vezenov, P. Sullivan, W. Haimberger, and L. Thulin, “Near-field optical recording without low flying: integral near-field optical media”, Jpn. J. Appl. Phys. Vol. 41, pp.1866-1875, 2002). However, when this technique is adopted on the conventional magnetic optical disk, although the recording bit may be greatly shrunk, the operation of reading signals of the magnetic optical records is accomplished by detecting the Kerr angle of the reflection light. The Kerr effect diminishes with the shrinking of the detection area. Hence, when the magnetic area of the disk record is very small, namely the recording density is very high, the reflection light becomes weak and the signals might become not readable. It is not convenient in applications.

On the other hand, on the magnetic recording media, in order to increase the recording density, Hideki et al proposed a new thermal-magnetic recording and flux detection method in 1998 that combines the advantages of the magnetic optical disk which may form a clear vertical magnetic zone and the highly sensitive giant magneto-resistive head (GMR head) (H. Saga, H. Nemoto, H. Sukeda, and M. Takahashi, “New recording method combining thermo-magnetic recording and flux dection”, Jpn. J. Appl. Phys. Vol. 38, pp.1839-1840, 1999). The recording film is a conventional magnetic optical material. It uses the conventional thermal-magnetic recording method to record signals. It uses the GMR head to measure the magnetic flux to read signals. But the conventional magnetic optical materials are not suitable recording media for thermal recording and magnetic reading. This because the saturation magnetization (Ms) at room temperature is too small and cannot provide a sufficient magnetic flux for the GMR head to read signals.

### SUMMARY OF THE INVENTION

In order to resolve the problems set forth above, the invention provides a high density thermal recording and magnetic reading recording medium and system that reduces the weight of the slider of the pickup head and simplifies the design thereof, and can greatly increase the recording density of the disk.

The high density thermal recording and magnetic reading recording medium and system according to the invention combines INFO recording and the sensitive reading technique of magneto-resistance head to overcome the limitation of optical diffraction to increase the density of recording media. The system includes a near-field optical laser, magneto-resistive head and a recording medium. The recording medium has a sub-micro cylindrical SIL so that when the near-field optical laser writes, an optical effect is generated to shrink the optical spot, and the recording medium can have a smaller recording bit to increase the recording density. Thereby the near-field optical laser can achieve the near-field optical recording effect without being close to the recording medium. As a result, the hitting and scraping problem that might otherwise occur, because to the laser is too close to the recording medium, may be avoided. Coupled with the magneto-resistive head to read data, the weight of the slider can be reduced and the design of the slider can be simplified.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a first embodiment of the invention.

FIG. 2 is a schematic view of a second embodiment of the invention.

### DESCRIPTION OF THE PREFERRED EMBODIMENTS

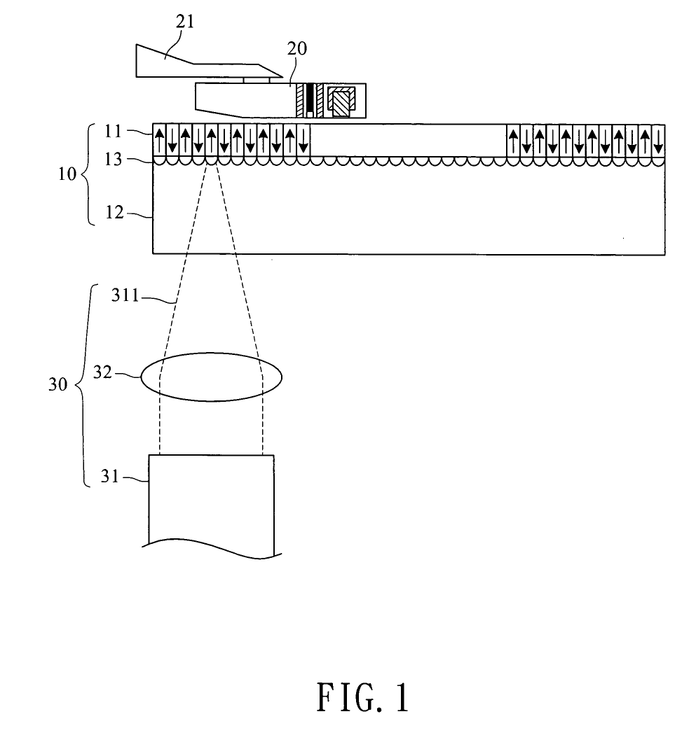

Referring to FIG. 1, the high-density thermal recording and magnetic reading recording medium and system according to the invention includes a near-field optical laser 30, a recording medium 10 and a magneto-resistive head 20. The recording medium 10 includes a substrate 12 and a recording layer 11 bonding and covering one side of the substrate 12. There are sub-micro cylindrical lenses 13 located between the substrate 12 and the recording layer 11. The substrate 12 can be made of glass. The sub-micro cylindrical SILs cover the lower side of the entire recording layer 11 so that laser light 311 emitted from the laser head 31 of the near-field optical laser 30 can generate a near-field optical effect to form smaller optical spots on the recording layer 11, thereby forming smaller recording bits and increasing the recording density. It also resolves the interface scraping problem that occurs to the general near-field optical system because the optical head and the recording medium are too close. The material may be ZnS. SiO₂ or SiNx, and the effective numerical aperture is greater than 1.1.

On the other hand, a magneto-resistive head 40 is used to read the data on the recording layer 11. It does not require a specially designed slider 21 to perform reading. Thus the weight of the slider (not shown in the drawings) can be reduced. The magneto-resistive head 40 can be a GMR head or Tunneling Magneto-resistance head (TMR head). A TMR head is preferred. The recording layer 11 is a magnetic recording film, which has a high saturation magnetization (Ms) and high vertical film surface coercive force (Hc) at room temperature. When the temperature rises, the vertical film surface coercive force drops rapidly to facilitate thermal-magnetic recording.

For recording data, the laser head 31 emits the laser light 311 which passes through a converging lens 32 and the substrate 12 to generate a near-field optical effect through the sub-micro cylindrical lenses 13, so that the recording layer 11 is magnetized. The magnetized direction is preferably normal to the surface (indicated by arrows in the drawing). Thereby, the recording density may increase. For reading, the magneto-resistive head 20 reads from one side of the recording layer 11. Thus the weight of the slider can be reduced and the design of the slider 21 can be simplified.

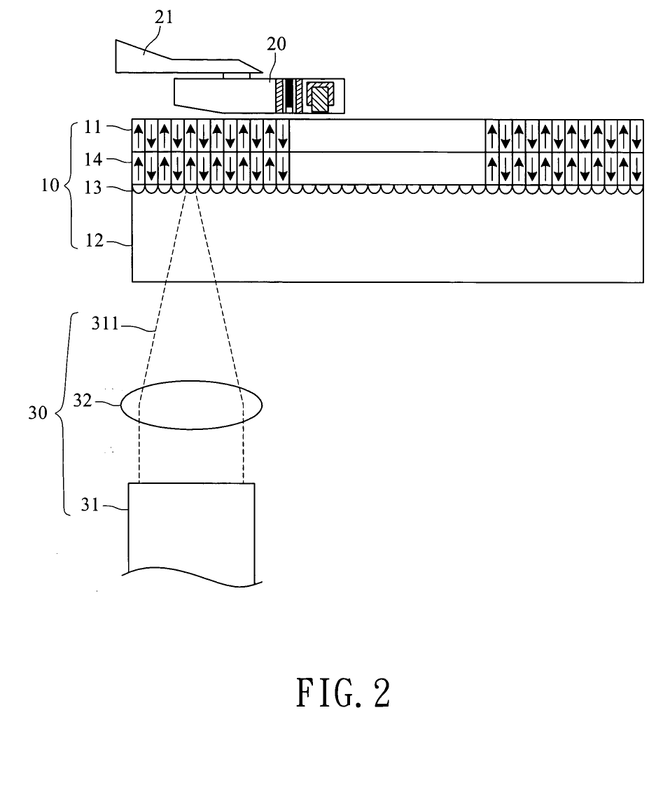

Refer to FIG. 2 for a second embodiment of the invention. Taking into account the exposed recording layer 11 tends to incur wearing or demagnetizing, a reading layer 14 is formed on an outer side to replicate the data of the recording layer 11 to be read by the magneto-resistive head 20. The rest of the operations and principles are the same as those previously discussed. It also can increase the recording density and reduce the weight of the slider. Details are omitted.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A high-density thermal recording and magnetic reading recording medium containing data written by a near-field optical laser and readable by a magneto-resistive head, comprising:
a substrate;
a recording layer formed on one side of the substrate; and
a plurality of sub-micro cylindrical lenses formed between the substrate and the recording layer;
wherein the near-field optical laser writes the data on the recording payer and generates a near-field optical effect to shrink the dimension of optical spots and increase the recording density of the recording layer, the data written on the recording layer being readable by the magneto-resistive head.

2. The high-density thermal recording and magnetic reading recording medium of claim 1, wherein the substrate is made from glass.

3. The high density thermal recording and magnetic reading recording medium of claim 1, wherein the sub-micro cylindrical lenses have an effective numerical aperture greater than 1.1.

4. The high-density thermal recording and magnetic reading recording medium of claim 3, wherein the sub-micro cylindrical lenses are solid immersion lenses.

5. The high-density thermal recording and magnetic reading recording medium of claim 4, wherein the sub-micro cylindrical lenses are made from a material selecting from a group consisting of ZnS.SiO₂ and SiNx.

6. The high-density thermal recording and magnetic reading recording medium of claim 1, wherein the recording layer is a magnetic recording film.

7. The high-density thermal recording and magnetic reading recording medium of claim 6, wherein the magnetic recording film has a reading layer located thereon.

8. The high-density thermal recording and magnetic reading recording medium of claim 1, wherein the recording layer is a magnetic optical recording layer.

9. The high density thermal recording and magnetic reading recording medium of claim 8, wherein the magnetic optical recording layer has a reading layer located thereon.

10. The high density thermal recording and magnetic reading recording medium of claim 1, wherein the recording layer is magnetized in a direction normal to the surface of the recording layer.

11. A high density thermal recording and magnetic reading system, comprising:
a recording medium which includes a substrate, a recording layer formed on the substrate and a plurality of sub-micro cylindrical lenses formed between the substrate and the recording layer;
a near-field optical laser located on one side of the recording medium for recording data on the recording layer and generating a near-field optical effect to shrink the dimension of optical spots to increase the recording density of the recording layer; and
a magneto-resistive head located on another side of the recording layer to read the data written on the recording layer.

12. The high-density thermal recording and magnetic reading system of claim 11, wherein the substrate is made from glass.

13. The high-density thermal recording and magnetic reading system of claim 11, wherein the sub-micro cylindrical lenses have an effective numerical aperture greater than 1.1.

14. The high-density thermal recording and magnetic reading system of claim 13, wherein the sub-micro cylindrical lenses are solid immersion lenses.

15. The high-density thermal recording and magnetic reading system of claim 14, wherein the sub-micro cylindrical lenses are made from a material selecting from a group consisting of ZnS.SiO₂ and SiNx.

16. The high-density thermal recording and magnetic reading system of claim 11, wherein the recording layer is a magnetic recording film.

17. The high-density thermal recording and magnetic reading system of claim 16, wherein the magnetic recording film has a reading layer located thereon.

18. The high-density thermal recording and magnetic reading system of claim 11, wherein the recording layer is a magnetic optical recording layer.

19. The high-density thermal recording and magnetic reading system of claim 18, wherein the magnetic optical recording layer has a reading layer located thereon.

20. The high-density thermal recording and magnetic reading system of claim 11, wherein the recording layer is magnetized in a direction normal to the surface of the recording layer.

21. The high-density thermal recording and magnetic reading system of claim 11, wherein the magneto-resistive head is selectively a giant magneto-resistive head or a tunneling magneto-resistance head.
